(19) United States
(12) Patent Application Publication
(10) Pub. No.: US 2026/0045204 A1
(43) Pub. Date: Feb. 12, 2026

(54) DISPLAY APPARATUS, METHOD OF DRIVING THE SAME AND ELECTRONIC APPARATUS INCLUDING THE SAME

(71) Applicant: SAMSUNG DISPLAY CO., LTD., YONGIN-SI (KR)

(72) Inventors: SEHYUK PARK, Yongin-si (KR); DONGGYU LEE, Yongin-si (KR); Seongoh Yeom, Yongin-si (KR); JAKYOUNG JIN, Yongin-si (KR)

(21) Appl. No.: 19/211,610

(22) Filed: May 19, 2025

(30) Foreign Application Priority Data
Aug. 12, 2024 (KR) 10-2024-0107635

(51) Int. Cl. G09G 3/32

(52) U.S. Cl. CPC G09G 3/32; G09G 2300/0819; G09G 2310/0267; G09G 2310/0275; G09G 2310/08; G09G 2320/0233; G09G 2320/0247; G09G 2320/0285; G09G 2330/021

(57) ABSTRACT

A display apparatus includes a display panel including a pixel and a display panel driver which output a gate signal, a data voltage, and an emission signal to the pixel. The display apparatus determines whether a driving cycle in a driving sequence is a writing cycle or a holding cycle, determines a holding cycle number of a present holding cycle when holding cycles are repeated in the driving sequence, and determines an emission off time based on the holding cycle number of the present holding cycle by adjusting at least one of an end point of the off duration of the emission signal and a start point of the off duration of the emission signal according to a setting value. Because a luminance difference between the writing cycle and the later portion of the holding cycles is reduced, the display quality of the display apparatus is enhanced.

### CROSS-REFERENCE TO RELATED APPLICATION

This application claims priority under 35 U.S.C. § 119 to Korean Patent Application No. 10-2024-0107635, filed on Aug. 12, 2024 in the Korean Intellectual Property Office KIPO, the disclosure of which is incorporated by reference herein in its entirety.

### TECHNICAL FIELD

Embodiments of the present inventive concept relate to a display apparatus, a method of driving the display apparatus and an electronic apparatus including the display apparatus. More particularly, embodiments of the present inventive concept relate to a display apparatus enhancing a display quality of the display apparatus by reducing luminance variation at low driving frequency.

### DISCUSSION OF THE RELATED ART

A display apparatus may include a display panel and a display panel driver. The display panel includes a plurality of gate lines, a plurality of data lines, a plurality of emission lines and a plurality of pixels. The display panel driver includes a gate driver, a data driver, an emission driver, and a driving controller. The gate driver outputs gate signals to the gate lines. The data driver outputs data voltages to the data lines. The emission driver outputs emission signals to the emission lines. The driving controller controls the gate driver, the data driver, and the emission driver.

The display apparatus may perform a driving sequence for displaying an image on the display panel at various different driving frequencies. The driving sequence may include a writing cycle and a holding cycle. During the writing cycle, the display panel receives the data voltages from the data lines and emits light based on the received data voltages, and during the holding cycle, the display panel emits light based on stored data voltages stored in the plurality of pixels.

When the display apparatus drives the display panel at a low driving frequency, a number of the holding cycles in a frame may be increased, and luminance of the display panel may be decreased as the holding cycles are repeated. By compensating the luminance variation of the display panel at the low driving frequency, display quality of the display apparatus is improved.

### SUMMARY

Embodiments of the present inventive concept provide a display apparatus adjusting a light emission time of a pixel based on determining whether a driving cycle in a driving sequence is a writing cycle or a holding cycle and determining a holding cycle number of a present holding cycle, and selectively adjusting one of an end point of an off duration of an emission signal and a start point of the off duration of the emission signal. According to an embodiment, a display apparatus includes a display panel including a pixel, and a display panel driver including a gate driver, a data driver, and an emission driver, in which the gate driver, the data driver, and the emission driver are configured to generate a gate signal, a data voltage, and an emission signal respectively, and to provide the gate signal, the data voltage, and the emission signal to the display panel, wherein the display panel driver is further configured to determine whether a driving cycle in a driving sequence is a writing cycle or a holding cycle, in which, during the writing cycle, the display panel is configured to receive the data voltage, write the data voltage into the pixel, and to drive a light emitting element of the pixel to emit light based on the data voltage, and during the holding cycle, the display panel is configured not to receive the data voltage, and to drive the light emitting element of the pixel to emit light based on the data voltage stored in the pixel, determine a holding cycle number of a present holding cycle when holding cycles are repeated in the driving sequence, and determine an emission off time based on the holding cycle number of the present holding cycle by adjusting at least one of an end point of the off duration of the emission signal and a start point of the off duration of the emission signal according to a setting value.

When the holding cycle number of the present holding cycle is equal to or greater than a predetermined holding cycle reference number, the display panel driver is configured to decrease the emission off time by advancing the end point of the off duration of the emission signal and/or by delaying the start point of the off duration of the emission signal according to the setting value, and the display panel driver is configured to increase an emission on time to be longer than a reference emission on time.

When the holding cycle number of the present holding cycle is equal to or greater than the predetermined holding cycle reference number, the display panel driver is configured to increase a bias voltage applied to a driving switching element of the pixel to be greater than a reference bias voltage.

When the setting value is a first value, the display panel driver is configured to advance the end point of the off duration of the emission signal to decrease the emission off time, and when the setting value is a second value, the display panel driver is configured to delay the start point of the off duration of the emission signal to reduce overall emission off time.

When the setting value is a third value, the display panel driver is configured to advance the end point of the off duration of the emission signal and to delay the start point of the off duration of the emission signal to reduce overall emission off time. The display panel driver further includes a signal generator configured to generate a vertical start signal and a data enable signal, and a cycle counter configured to determine whether a present driving cycle is the writing cycle or the holding cycle based on the vertical start signal and the data enable signal, and the cycle counter is further configured to determine the holding cycle number of the present holding cycle based on the vertical start signal and the data enable signal when the holding cycles are repeated in the driving sequence.

The cycle counter determines the present driving cycle as the writing cycle when the cycle counter receives pulses of the data enable signal repeatedly after receiving the vertical start signal, and the cycle counter determines the present driving cycle as the holding cycle when the cycle counter does not receive the pulses of the data enable signal after receiving the vertical start signal.

The display panel driver further includes a lookup table configured to store the emission off time corresponding to the holding cycle number.

The display panel driver further includes a register configured to determine the emission off time corresponding to the holding cycle number based on an emission off setting, and to output the emission off time corresponding to the holding cycle number from the lookup table.

The display panel driver further includes an emission off time output circuit configured to receive the holding cycle number of the present holding cycle from the cycle counter and configured to output the emission off time corresponding to the holding cycle number from the lookup table. The display panel driver further includes a position setter configured to output the setting value with which the emission driver determines whether to change the end point of the off duration of the emission signal or to change the start point of the off duration of the emission signal, and an emission driver configured to generate the emission signal based on the emission off time received from the emission off time output circuit and the setting value received from the position setter, and to provide the emission signal to the pixel. The pixel includes a driving switching element including a control electrode of the driving switching element connected to a first node, a first electrode of the driving switching element connected to a second node and a second electrode of the driving switching element connected to a third node, a bias switching element including a control electrode of the bias switching element configured to receive a bias gate signal, a first electrode of the bias switching element configured to receive a bias voltage and a second electrode of the bias switching element connected to the second node, a first emission switching element including a control electrode of the first emission switching element configured to receive the emission signal, a first electrode of the first emission switching element configured to receive a first power voltage and a second electrode of the first emission switching element connected to the second node, a second emission switching element including a control electrode of the second emission switching element configured to receive the emission signal, a first electrode of the second emission switching element connected to the third node and a second electrode of the second emission switching element connected to a first electrode of the light emitting element, a data writing switching element including a control electrode of the data writing switching element configured to receive a data writing gate signal, a first electrode of the data writing switching element configured to receive the data voltage and a second electrode of the data writing switching element connected to the second node, a compensation switching element including a control electrode of the compensation switching element configured to receive a compensation gate signal, a first electrode of the compensation switching element connected to the first node and a second electrode of the compensation switching element connected to the third node, a data initialization switching element including a control electrode of the data initialization switching element configured to receive a data initialization gate signal, a first electrode of the data initialization switching element configured to receive an initialization voltage and a second electrode of the data initialization switching element connected to the first node, and a light emitting element initialization switching element including a control electrode of the light emitting element initialization switching element configured to receive the bias gate signal, a first electrode of the light emitting element initialization switching element configured to receive a light emitting element initialization voltage and a second electrode of the light emitting element initialization switching element connected to the first electrode of the light emitting element.

The compensation switching element includes two transistors connected to each other in series, and the data initialization switching element includes two transistors connected to each other in series. According to an embodiment of a method of driving a display apparatus, the method includes determining whether a driving cycle in a driving sequence is a writing cycle or a holding cycle, in which, during the writing cycle, the display apparatus is configured to generate a data voltage and write the data voltage into a pixel, and to drive a light emitting element of the pixel to emit light based on the data voltage, and during the holding cycle, the display apparatus is configured to drive the light emitting element of the pixel to emit light based on the data voltage stored in the pixel, determining a holding cycle number of a present holding cycle when holding cycles are repeated in a driving sequence, determining an emission off time based on the holding cycle number of a present holding cycle by adjusting at least one of an end point of an off duration of an emission signal and a start point of the off duration of the emission signal according to a setting value, and generating the emission signal based on the emission off time and the setting value, and providing the emission signal to the pixel.

When the holding cycle number of the present holding cycle is equal to or greater than a predetermined holding cycle reference number, the emission off time is decreased by advancing the end point of the off duration of the emission signal and/or by delaying the start point of the off duration of the emission signal according to the setting value.

When the holding cycle number of the present holding cycle is equal to or greater than the predetermined holding cycle reference number, a bias voltage applied to a driving switching element of the pixel is increased to be greater than a reference bias voltage.

When the setting value is a first value, the end point of the off duration of the emission signal is advanced to decrease the emission off time, and when the setting value is a second value, the start point of the off duration of the emission signal is delayed to reduce overall emission off time.

A present driving cycle is determined to be one of the writing cycle or the holding cycle based on a vertical start signal and a data enable signal, and the holding cycle number of the present holding cycle is determined based on the vertical start signal and the data enable signal when the holding cycles are repeated in the driving sequence. According to an embodiment of an electronic apparatus, the electronic apparatus includes a processor configured to output input image data and an input control signal, a display panel including a pixel, and a display panel driver including a gate driver, a data driver, and an emission driver, in which the gate driver, the data driver, and the emission driver are configured to generate a gate signal, a data voltage and an emission signal respectively, and to provide the gate signal, the data voltage, and the emission signal to the pixel, wherein the display panel driver is further configured to determine whether a driving cycle in a driving sequence is a writing cycle or a holding cycle, in which, during the writing cycle, the display panel is configured to receive the data voltage, write the data voltage into the pixel, and to drive a light emitting element of the pixel to emit light based on the data voltage, and during the holding cycle, the display panel is configured not to receive the data voltage, and to drive the light emitting element of the pixel to emit light based on the data voltage stored in the pixel, determine a holding cycle number of a present holding cycle when holding cycles are repeated in the driving sequence, and determine an emission off time based on the holding cycle number of the present holding cycle by adjusting at least one of an end point of the off duration of the emission signal and a start point of the off duration of the emission signal according to a setting value,

The display panel driver is further configured to determine whether the driving cycle is the writing cycle or the holding cycle based on the input control signal from the processor.

### BRIEF DESCRIPTION OF THE DRAWINGS

The features and advantages of the inventive concept will become more apparent by describing embodiments in detail with reference to the accompanying drawings, in which:

FIG. 1 is a block diagram illustrating a display apparatus according to an embodiment of the present inventive concept;

FIG. 2 is a diagram illustrating a driving frequency of a display panel of FIG. 1;

FIG. 3 is a circuit diagram illustrating a pixel of the display panel of FIG. 1;

FIG. 4 is a diagram illustrating a driving sequence at various different driving frequencies of the display panel of FIG. 1;

FIG. 5 is a diagram illustrating a driving sequence at various different driving frequencies of the display panel of FIG. 1;

FIG. 6 is a timing diagram illustrating input signals applied to the display panel of FIG. 1 in a writing cycle;

FIG. 7 is a timing diagram illustrating input signals applied to the display panel of FIG. 1 in a holding cycle;

FIG. 8A is a timing diagram illustrating a luminance of the display panel of FIG. 1 when the display apparatus drives the display panel without a light emission time control;

FIG. 8B is a timing diagram illustrating a luminance of the display panel of FIG. 1 when the display apparatus drives the display panel with a light emission time control;

FIG. 9 is a block diagram illustrating a driving controller of FIG. 1;

FIG. 10 is a table illustrating a setting value of a position setter of FIG. 9;

FIGS. 11A and 11B are a timing diagram illustrating a method of adjusting an end point of an off duration of an emission signal of FIG. 10;

FIGS. 12A and 12B are a timing diagram illustrating a method of adjusting a start point of the off duration of the emission signal of FIG. 10;

FIG. 13 is a table illustrating a method of adjusting an emission off time according to a setting value of a position setter of a display apparatus;

FIGS. 14A and 14B are a timing diagram illustrating a method of adjusting both of a start point and an end point of an off duration of an emission signal of FIG. 13;

FIG. 15 is a circuit diagram illustrating a pixel of a display panel;

FIG. 16 is a block diagram illustrating an electronic apparatus according to an embodiment of the present inventive concept;

FIG. 17 illustrates a smart phone as an example of the electronic apparatus of FIG. 16;

FIG. 18 illustrates a monitor as an example of the electronic apparatus of FIG. 16; and

FIG. 19 is a block diagram illustrating an electronic apparatus according to an embodiment of the present inventive concept.

### DETAILED DESCRIPTION OF THE INVENTIVE CONCEPT

Hereinafter, the present inventive concept will be explained in detail with reference to the accompanying drawings.

A display apparatus includes a display panel including a pixel and a display panel driver which output a gate signal, a data voltage, and an emission signal to the pixel. The display apparatus determines whether a driving cycle in a driving sequence is a writing cycle or a holding cycle in which a light emitting element of the pixel emits light based on the data voltage received from a data driver during the writing cycle, and the light emitting element of the pixel emits light based on the data voltage stored in the pixel, determines a holding cycle number of a present holding cycle when holding cycles are repeated in the driving sequence, and determines an emission off time based on the holding cycle number of the present holding cycle by adjusting at least one of an end point of an off duration of the emission signal and a start point of the off duration of the emission signal according to a setting value.

Because a light emission time in a later portion of the holding cycles is increased by adjusting at least one of an end point of the off duration of the emission signal and a start point of the off duration of the emission signal, a luminance difference between the writing cycle and the later portion of the holding cycles is reduced and the display quality of the display apparatus is enhanced.

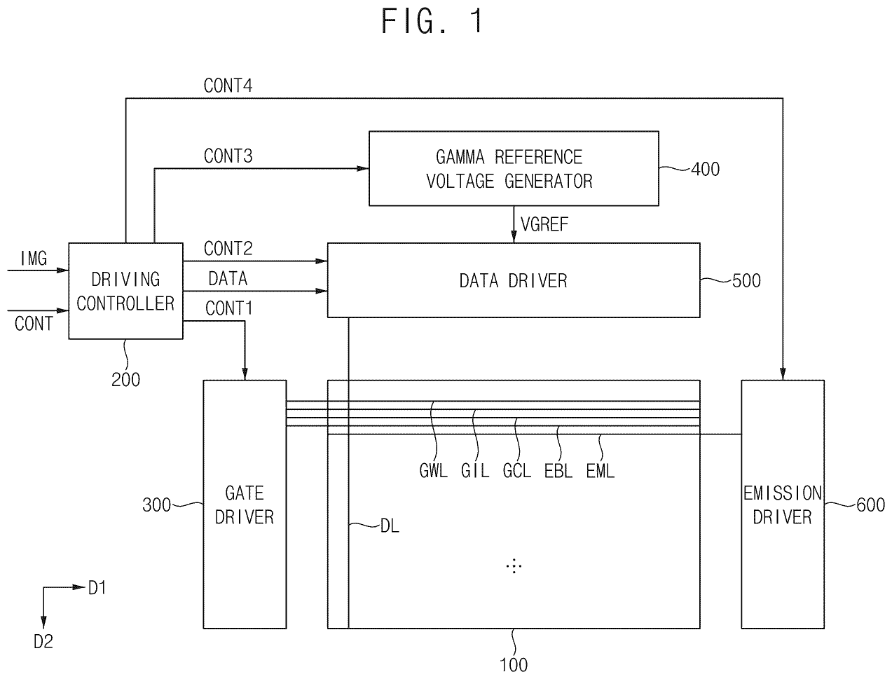

FIG. 1 is a block diagram illustrating a display apparatus according to an embodiment of the present inventive concept.

Referring to FIG. 1, the display apparatus includes a display panel 100 and a display panel driver. The display panel 100 includes a plurality of pixels. The display panel driver includes a driving controller 200, a gate driver 300, a gamma reference voltage generator 400, a data driver 500 and an emission driver 600.

The display panel 100 has a display region on which an image is displayed by the plurality of pixels and a peripheral region adjacent to the display region in which the display panel driver is disposed.

The display panel 100 includes a first to fourth gate lines GWL, GIL, GCL and EBL, a plurality of data lines DL, a plurality of emission lines EML and a plurality of pixels electrically connected to the first to fourth gate lines GWL, GIL, GCL and EBL, the data lines DL and the emission lines EML. The first to fourth gate lines GWL, GIL, GCL and EBL may extend in a first direction D1, the data lines DL may extend in a second direction D2 perpendicular to the first direction D1 and the emission lines EML may extend in the first direction D1.

The driving controller 200 receives input image data IMG and an input control signal

CONT from an external apparatus such as an application processor. For example, the input image data IMG may include red image data, green image data and blue image data. The input image data IMG may further include white image data, magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, and a fourth control signal CONT4 based on the input control signal CONT, and the driving controller 200 may further generate a data signal DATA based on the input image data IMG.

The driving controller 200 generates the first control signal CONT1 for controlling an operation of the gate driver 300 based on the input control signal CONT, and provides the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and provides the second control signal CONT2 to the data driver 500. The second control signal CONT2 may include a horizontal start signal and a load signal.

The driving controller 200 generates the data signal DATA based on the input image data IMG, and provides the data signal DATA to the data driver 500.

The driving controller 200 generates the third control signal CONT3 for controlling an operation of the gamma reference voltage generator 400 based on the input control signal CONT, and provides the third control signal CONT3 to the gamma reference voltage generator 400.

The driving controller 200 generates the fourth control signal CONT4 for controlling an operation of the emission driver 600 based on the input control signal CONT, and provides the fourth control signal CONT4 to the emission driver 600.

The gate driver 300 generates first to fourth gate signals for driving the first to fourth gate lines GWL, GIL, GCL and EBL in response to the first control signal CONT1 received from the driving controller 200. The gate driver 300 may provide the first to fourth gate signals to the first to fourth gate lines GWL, GIL, GCL and EBL, respectively. The first to fourth gate signals may corresponds to a data initialization gate signal, a compensation gate signal, a data writing gate signal, and a bias gate signal, respectively.

According to an embodiment, the gate driver 300 may be embedded in the peripheral region of the display panel 100. Alternatively, the gate driver 300 may be mounted on the peripheral region of the display panel 100 as an independent chip.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a reference value for determining a level of the data signal DATA.

The gamma reference voltage generator 400 may be disposed in the driving controller 200, or may be embedded in the data driver 500.

The data driver 500 receives the second control signal CONT2 and the data signal

DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 provides the data voltages to the data lines DL.

The data driver 500 may be embedded in the peripheral region of the display panel 100. Alternatively, the data driver 500 may be mounted on the peripheral region of the display panel 100 as an independent chip.

The emission driver 600 generates an emission signal to drive the emission lines EML in response to the fourth control signal CONT4 received from the driving controller 200. The emission driver 600 may provide the emission signals to the emission lines EML.

According to an embodiment, the emission driver 600 may be embedded in the peripheral region of the display panel 100. Alternatively, the emission driver 600 may be mounted on the peripheral region of the display panel 100 as an independent chip.

The gate driver 300 may be disposed on a first side of the display panel 100 and the emission driver 600 may be disposed on a second side of the display panel 100 opposite to the first side of the display panel 100. However, the present inventive concept may not be limited thereto. For example, both of the gate driver 300 and the emission driver 600 may be disposed on the first side of the display panel 100. Alternatively, both of the gate driver 300 and the emission driver 600 may be divided and disposed on both sides of the display panel 100. In addition, the gate driver 300 and the emission driver 600 may be disposed as an integrated circuit block.

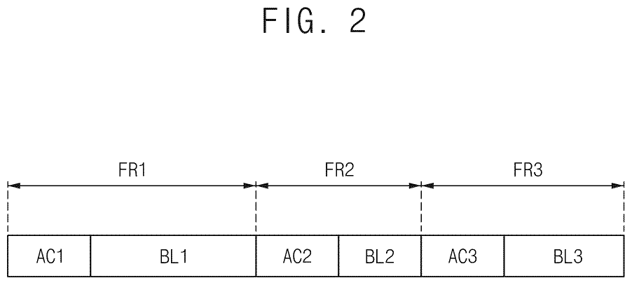

FIG. 2 is a diagram illustrating a driving frequency of the display panel 100 of FIG. 1.

Referring to FIGS. 1 and 2, the display apparatus may drive the display panel 100 at various different driving frequencies. For example, the display apparatus may drive the display panel 100 at a first driving frequency during a first frame, at a second driving frequency during a second frame, and at a third driving frequency during a third frame, in which the first to third driving frequencies are different from each other. The first frame FR1 displayed at the first driving frequency may include a first active period AC1 and a first blank period BL1. A second frame FR2 displayed at a second driving frequency may include a second active period AC2 and a second blank period BL2. A third frame FR3 displayed at a third driving frequency may include a third active period AC3 and a third blank period BL3.

A length of the first active period AC1 may be substantially same as a length of the second active period AC2. However, due to different driving frequencies, a length of the first blank period BL1 may be different from a length of the second blank period BL2.

A length of the second active period AC2 may be the same as a length of the third active period AC3. The second blank period BL2 may be different from a length of the third blank period BL3.

The display apparatus may drive the display panel 100 at various different driving frequencies for driving cycles of a driving sequence. The driving sequence may include a writing cycle and a holding cycle. During the writing cycle, the display panel 100 receives the data voltage VDATA from the data driver 500 and writes the data voltage into the pixel, and a light emitting element of the pixel emits light based on the data voltage. During the holding cycle, the display panel stop receiving the data voltage from the data driver 500, and the light emitting element of the pixel emits light based on stored data voltages in the pixel which are previously received during the writing cycle. The writing cycle may correspond to the first to third active periods AC1, AC2 and AC3, and the holding cycle may correspond to the first to third blank periods BL1, BL2 and BL3.

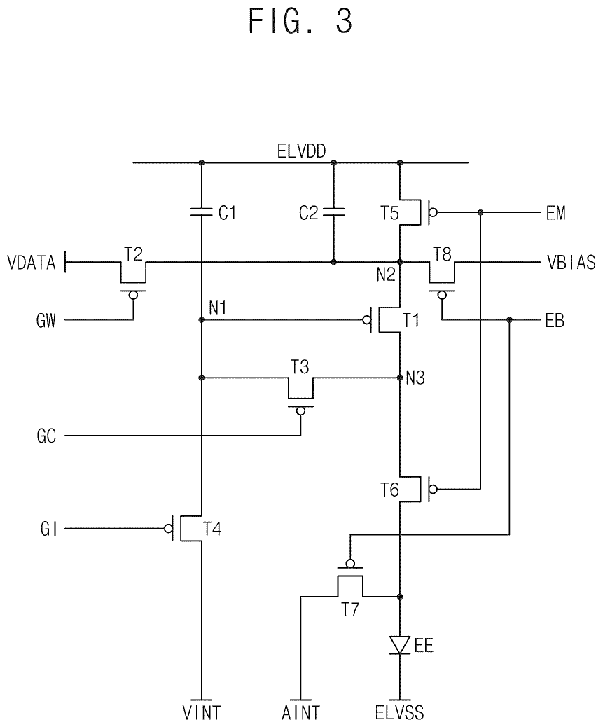

FIG. 3 is a circuit diagram illustrating the pixel of the display panel 100 of FIG. 1.

Referring to FIGS. 1 to 3, the pixel may include a light emitting element EE, a driving switching element T1, and a bias switching element T9. The driving switching element T1 may drive a driving current to the light emitting element EE and a bias switching element T9 may supply a bias voltage VBIAS to the driving switching element T1. The pixel may further include a bias switching element T8, a first emission switching element T5, a second emission switching element T6, a data writing switching element T2, a compensation switching element T3, a data initialization switching element T4 and a light emitting element initialization switching element T7. When a light emission time of the pixel increases, a level of the bias voltage VBIAS supplied to the driving switching element T1 may increase.

The driving switching element T1 may include a control electrode connected to a first node N1, a first electrode connected to a second node N2 and a second electrode connected to a third node N3. The bias switching element T8 may include a control electrode receiving a bias gate signal EB, a first electrode receiving the bias voltage VBIAS and a second electrode connected to the second node N2. The first emission switching element T5 may include a control electrode receiving the emission signal EM, a first electrode receiving a first power voltage ELVDD and a second electrode connected to the second node N2, and the second emission switching element T6 may include a control electrode receiving the emission signal EM, a first electrode connected to the third node N3 and a second electrode connected to a first electrode of the light emitting element EE. The data writing switching element T2 may include a control electrode receiving a data writing gate signal GW, a first electrode receiving the data voltage VDATA and a second electrode connected to the second node N2. The compensation switching element T3 may include a control electrode receiving a compensation gate signal GC, a first electrode connected to the first node N1 and a second electrode connected to the third node N3. The data initialization switching element T4 may include a control electrode receiving a data initialization gate signal GI, a first electrode receiving an initialization voltage VINT and a second electrode connected to the first node N1. The light emitting element initialization switching element T7 may include a control electrode receiving the bias gate signal EB, a first electrode receiving a light emitting element initialization voltage AINT and a second electrode connected to the first electrode of the light emitting element EE.

The pixel may further include a first capacitor C1 and a second capacitor C2. The first capacitor C1 may include a first electrode receiving the first power voltage ELVDD and a second electrode connected to the first node N1, and maintain the level of the data voltage VDATA applied to the control electrode N1 of the driving switching element T1.

The second capacitor C2 may include a first electrode receiving the first power voltage ELVDD and a second electrode connected to the second node N2.

A second power voltage ELVSS may be applied to a second electrode of the light emitting element EE.

Each of the driving switching element T1, the data writing switching element T2, the compensation switching element T3, the compensation switching element T3, the data initialization switching element T4, the first emission switching element T5, the second emission switching element T6, the light emitting element initialization switching element T7, and the bias switching element T8 may be P-type low temperature polysilicon (LTPS) thin film transistor.

The present inventive concept may not be limited to a pixel structure of FIG. 3. For example, the pixel may further include additional transistors and/or additional capacitors, and the transistors T1 to T8 may be connected differently from the pixel structure of FIG. 3. The transistors T1 to T8 may be implemented in N-Type transistors.

FIG. 4 is a diagram illustrating a driving sequence at various different driving frequencies of the display panel 100 of FIG. 1.

Referring to FIGS. 1 to 4, the display apparatus may drive the display panel 100 at various different driving frequencies depending on applications. For example, the display apparatus may drive the display panel 100 at a high driving frequency for displaying a moving image. On the contrary, the display apparatus may drive the display panel 100 at a low frequency for displaying a static image. In addition, the display apparatus may drive the display panel 100 at a high frequency to avoid a flicker in the image displayed on the display panel 100, and the display apparatus may drive the display panel 100 at a low frequency when an effect of the flicker in the image displayed on the display panel 100 is small.

According to an embodiment, a maximum driving frequency of the display panel 100 may be 240 Hz as shown in FIG. 4. However, the present inventive concept may not be limited thereto.

The driving sequence of the display panel 100 may include a writing cycle WR and a holding cycle HL. During the writing cycle WR, the display panel 100 receives the data voltage VDATA from the data driver 500, and applies the data voltage VDATA to the first electrode of the driving switching element T1, and the driving switching element T1 drives a driving current to the first electrode of the light emitting element EE for the light emitting element EE to emit light based on the driving current. During the holding cycle HL, the display panel 100 may stop receiving the data voltage VDATA, and the light emitting element EE emits light based on stored data voltage in the second capacitor C2 which is connected between the first power voltage ELVDD and the first electrode of the driving switching element T1. During the writing cycle WR, the gate driver 300 drives an activation level of the data writing gate signal GW to a gate electrode of the data writing switching element T2 for the data writing switching element T2 to be turned on, and the stored data voltage VDATA may be applied to the first electrode of the driving switching element T1. During the holding cycle HL, the gate driver 300 drives a deactivation level of the data writing gate signal GW to the gate electrode of the data writing switching element T2 for the data writing switching element T2 to be turned off, in which the data voltage VDATA may not be applied to the first electrode of the driving switching element T1.

According to an embodiment, a frame may be displayed by a single writing cycle at maximum driving frequency (e.g. 240 Hz) as shown in FIG. 4.

When the display apparatus drives the display panel 100 at driving frequency of 240 Hz, all of the first to eighth cycle periods P1 to P8 of FIG. 4 may be the writing cycles WR. Each of the first to eighth cycle periods P1 to P8 may be the single writing cycle in which writing operation and light emitting operation are performed.

When the display apparatus drives the display panel 100 at driving frequency of 120 Hz, a ratio between the writing cycle WR and the holding cycle HL may be 1:1, in which half of the driving cycles may be writing cycles and the other half of the driving cycles may be holding cycles. For example, the first cycle period P1, the third cycle period P3, the fifth cycle period P5 and the seventh cycle period P7 may be the writing cycles WR and the second period P2, the fourth cycle period P4, the sixth cycle period P6 and the eighth cycle period P8 may be the holding cycles HL. Each of the first to eighth cycle periods P1 to P8 may correspond to one cycle of the driving sequence, in which the first cycle period P1 and the second cycle period P2 may form a first frame, the third cycle period P3 and the fourth cycle period P4 may form a second frame, the fifth cycle period P5 and the sixth cycle period P6 may form a third frame and the seventh cycle period P7 and the eighth cycle period P8 may form a fourth frame.

When the display apparatus drives the display panel 100 at driving frequency of 60 Hz, a ratio between the writing cycle WR and the holding cycles HL may be 1:3, in which one-fourth of the driving cycles may be the writing cycle WR, three-fourths of the driving cycles may be the holding cycle HL. For example, the first cycle period P1 and the fifth cycle period P5 may be the writing cycles WR, and the second cycle period P2, the third cycle period P3, the fourth cycle period P4, the sixth cycle period P6, the seventh cycle period P7 and the eighth cycle period P8 may be the holding cycles HL. Each of the first to eighth cycle periods P1 to P8 corresponds to one cycle of the driving sequence, in which the first cycle period P1 to the fourth cycle period P4 may form a first frame, the fifth cycle period P5 to the eighth cycle period P8 may form a second frame.

When the display apparatus drives the display panel 100 at driving frequency of 30 Hz, a ratio between the writing cycle WR and the holding cycles HL may be 1:7, in which one-eighth of the driving cycles may be the writing cycle WR and seven-eighths of the driving cycles may be holding cycles HL. For example, the first cycle period P1 may be the writing cycle WR and the second cycle period P2, the third cycle period P3, the fourth cycle period P4, the fifth cycle period P5, the sixth cycle period P6, the seventh cycle period P7 and the eighth cycle period P8 may be the holding cycles HL. Each of the first to eighth periods P1 to P8 may correspond to one cycle of the driving sequence, in which the first cycle period P1 to the eighth cycle period P8 may form a first frame.

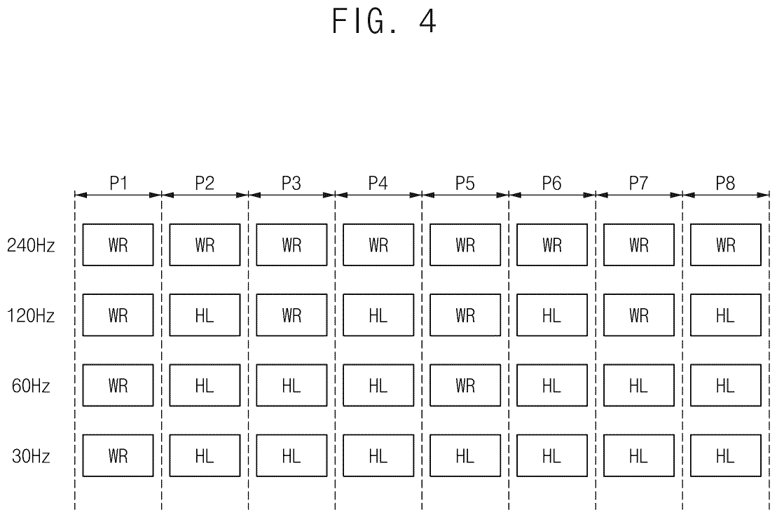

FIG. 5 is a diagram illustrating a driving sequence at various different driving frequencies.

The driving sequence shown in FIG. 5 may illustrate an example in which one frame is formed of two cycles at maximum driving frequency of 240 Hz.

When the display apparatus drives the display panel 100 at maximum driving frequency of 240 Hz, a ratio between the writing cycles WR and the holding cycles HL may be 1:1, in which half of the driving cycles of FIG. 5 may be the writing cycles WR and the other half of the driving cycles may be the holding cycles HL. For example, the first cycle period P1, the third cycle period P3, the fifth cycle period P5, the seventh cycle period P7 and the ninth cycle period P9 may be the writing cycles WR and the second cycle period P2, the fourth cycle period P4, the sixth cycle period P6, the eighth cycle period P8, and the tenth period P10 may be the holding cycles HL. Each of the first to tenth periods P1 to P10 may correspond to one cycle of the driving sequence, in which the first cycle period P1 and the second cycle period P2 may form a first frame, the third cycle period P3 and the fourth cycle period P4 may form a second frame, the fifth cycle period P5 and the sixth cycle period P6 may form a third frame, the seventh cycle period P7 and the eighth cycle period P8 may form a fourth frame, and the ninth cycle period P9 and the tenth cycle period P10 may form a fifth frame.

When the display apparatus drives the display panel 100 at driving frequency of 120 Hz, a ratio between the writing cycles WR and the holding cycles HL may be 1:3, in which one-fourth of the driving cycles may be the writing cycles WR and three-fourths of the driving cycles may be the holding cycles HL. For example, the first cycle period P1, the fifth cycle period P5, and the ninth cycle period P9 may be the writing cycles WR, and the second cycle period P2, the third cycle period P3, the fourth cycle period P4, the sixth cycle period P6, the seventh cycle period P7, the eighth cycle period P8, and the tenth cycle period P10 may be the holding cycles HL. Each of the first to tenth periods P1 to P10 may correspond to one cycle of the driving sequences, in which the first cycle period P1 to the fourth cycle period P4 may form a first frame, the fifth cycle period P5 to the eighth cycle period P8 may form a second frame, and the ninth cycle period P9 and the tenth cycle period P10 may form a part of a third frame.

When the display apparatus drives the display panel 100 at driving frequency of 60 Hz, a ratio between the writing cycle WR and the holding cycle HL may be 1:7, in which one-eighth of the driving cycles may be the writing cycles WR and seven-eighths of the driving cycles may be the holding cycles HL. For example, the first cycle period P1, and the ninth cycle period P9 may be the writing cycles WR and the second cycle period P2, the third cycle period P3, the fourth cycle period P4, the fifth cycle period P5, the sixth cycle period P6, the seventh cycle period P7, the eighth cycle period P8, and the tenth cycle period P10 may be the holding cycles HL. Each of the first to eighth cycle periods P1 to P10 may correspond to one cycle of the driving sequence, in which the first cycle period P1 to the eighth cycle period P8 may form a first frame, and the ninth cycle period P9 and the tenth cycle period P10 may form a part of a second frame.

When the display apparatus drives the display panel 100 at driving frequency of 48 Hz, a ratio between the writing cycle WR and the holding cycle HL may be 1:9, in which one-tenth of the driving cycles may be the writing cycles WR and nine-tenths of the driving cycles may be the holding cycle HL. For example, the first cycle period P1 may be the writing cycle WR and the second cycle period P2, the third cycle period P3, the fourth cycle period P4, the fifth cycle period P5, the sixth cycle period P6, the seventh cycle period P7, the eighth cycle period P8, a ninth cycle period P9 and a tenth cycle period P10 may be the holding cycles HL. Each of the first to tenth cycle periods P1 to P10 may correspond to one cycle of the driving sequence, in which the first cycle period P1 to the tenth cycle period P10 may form a first frame.

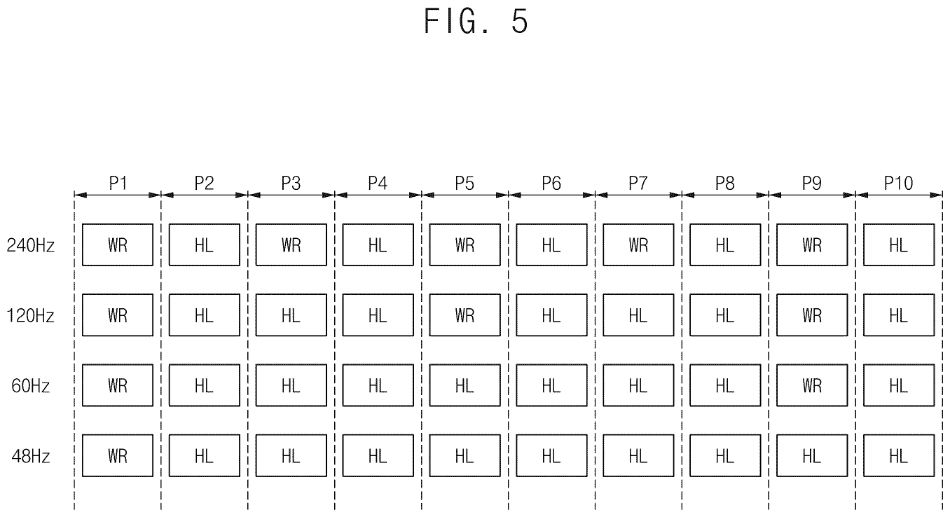

FIG. 6 is a timing diagram illustrating input signals applied to the display panel 100 of FIG. 1 during a writing cycle WR. FIG. 7 is a timing diagram illustrating the input signals applied to the display panel 100 of FIG. 1 during a holding cycle HL.

Referring to FIGS. 1 to 7, during the write cycle WR, an active pulses of the data initialization gate signal GI, the data writing gate signal GW, the compensation gate signal GC, and the bias gate signal EB may be applied to the pixel of FIG. 3 sequentially or parallelly. The active pulses of the gate signals may be a logic-low level.

When the active pulse of the data initialization gate signal GI is applied to the pixel, the data initialization switching element T4 may be turned on, and the initialization voltage VINT may be applied to the control electrode N1 of the driving switching element T1.

When the active pulses of the data writing gate signal GW and the compensation gate signal GC are applied to the pixel, the data writing switching element T2 and the compensation switching element T3 may be turned on. The data voltage VDATA may be applied to a second node N2 connected to the first electrode of the driving switching element T1 through the data writing switching element T2. Because the compensation switching element T3 is turned on, the driving switching element T1 is connected in a form of a diode, and the data voltage VDATA applied to the second node N2 drives the driving switching element T1. The data voltage VDATA applied to the second node N2 may be applied to the control electrode N1 of the driving switching element T1 after being compensated by a threshold voltage of the driving switching element T1.

When the active pulse of the bias gate signal EB is applied to the pixel, the light emitting element initialization switching element T7 and the bias switching element T8 may be turned on, in which the light emitting element initialization voltage AINT may be applied to the first electrode of the light emitting element EE, and the bias voltage VBIAS may be applied to the first electrode N2 of the driving switching element T1.

During the holding cycles HL of FIG. 7, the data initialization gate signal GI, the data writing gate signal GW, and the compensation gate signal GC may maintain an inactive level, thereby blocking the data voltage VDATA being applied to the second node N2. However, an active pulse of the bias gate signal EB may be applied for emitting light by the light emitting element EE. The inactive level of the gate signals may be a logic-high level and the active pulse may be a logic-low level.

During the holding cycle HL, the data initialization switching element T4 maintains turned off state and the voltage level of the first node N1 may be sustained by the first capacitor C1, and the data writing switching element T2 maintains turned off state and the voltage level of the second node N2 may be sustained by the second capacitor C2. Because the compensation switching element T3 maintains turned off state, the diode connection of the driving switching element T1 may be disconnected. However, in response to the active pulse of the bias gate signal EB during the holding cycle HL, the light emitting element initialization switching element T7 and the bias switching element T9 may be turned on. Therefore, a bias operation by the bias switching element T9 and a light emitting element initialization operation by the light emitting element initialization switching element T7 may be continuously performed during the holding cycles HL.

In the writing cycle WR of FIG. 6, while the active pulses of the data initialization gate signal GI, the data writing gate signal GW, and the compensation gate signal GC and the bias gate signal EB are applied to the pixel, the emission signal EM may have an inactive level until next data voltage received from the data driver 500 are written into the pixel. A pulse width of the emission signal EM in the holding cycle HL of FIG. 7 may be the same with a pulse width of the emission signal EM in the writing cycle WR of FIG. 6.

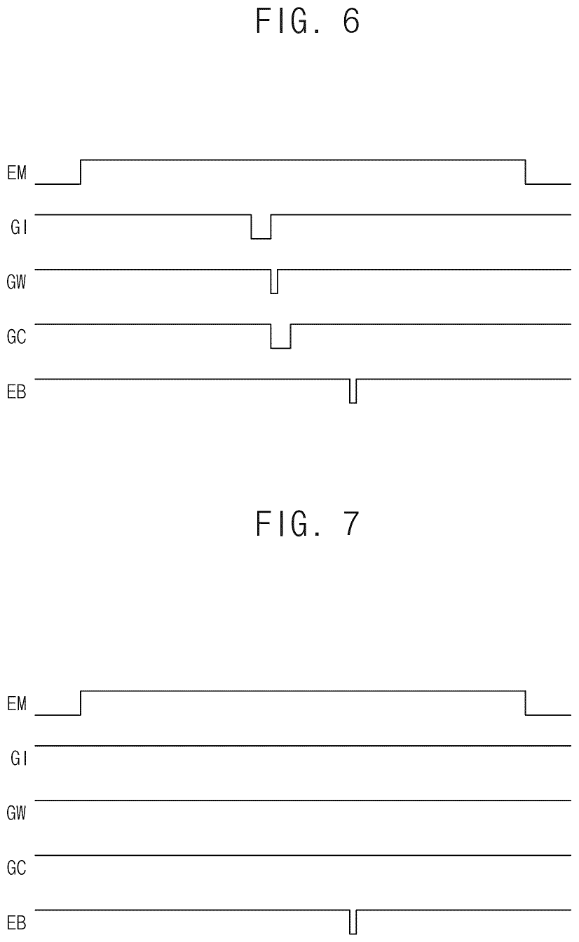

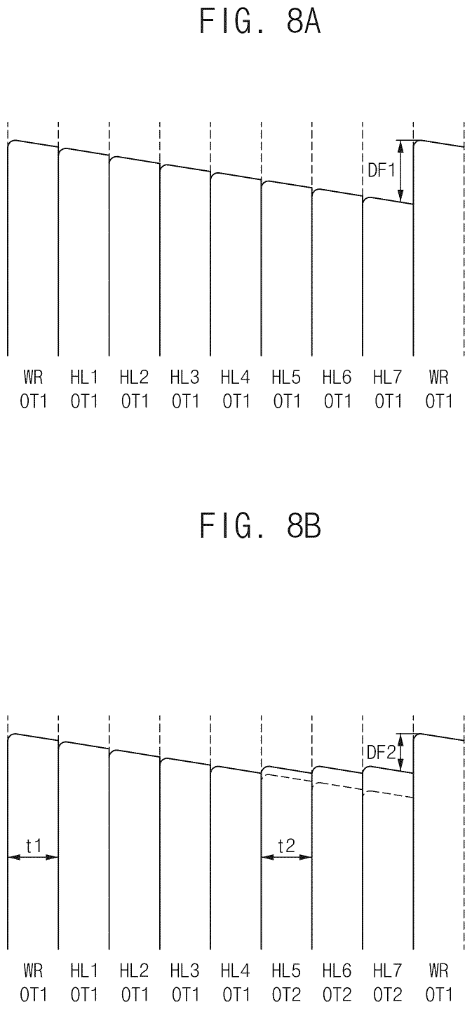

FIG. 8A is a timing diagram illustrating a luminance of the display panel 100 of FIG. 1 when the display apparatus drives the display panel without a light emission time control.

Referring to FIG. 8A, the display panel displays images during the writing cycle WR and the holding cycles HL1 to HL7. A frame of the driving sequence may include one writing cycle and a plurality of holding cycles at low driving frequency.

During the holding cycle at low driving frequency, the luminance of the display panel 100 may decrease gradually. Especially, the luminance of the display panel 100 may decrease rapidly in a high grayscale range.

The luminance of the display panel during the seventh holding cycle HL7 which is a last holding cycle of FIG. 8A may be lower than the luminance of the display panel during the writing cycle WR by a first difference DF1. The luminance difference may be recognized as a flicker to a user watching the display panel.

FIG. 8B is a timing diagram illustrating a luminance of the display panel 100 of FIG. 1 when the display apparatus drives the display panel with the light emission time control.

Unlike the luminance levels shown in FIG. 8A, the luminance level during the holding cycle may decrease slowly, and the flicker of the display panel 100 due to the luminance difference may be reduced.

Referring to FIG. 8B, the display panel 100 may compensate the luminance decrease by performing the light emission time control. The light emission time control may be performed by increasing a light emission time in a later portion of holding cycles (e.g. the fifth to seventh holding cycles HL5 to HL7) among the plurality of holding cycles while the display apparatus drives the display panel 100 at low driving frequency. For example, the display apparatus may drive the display panel with a first light emission time OT1 during the write cycle WR and an earlier portion of the holding cycles (e.g. the first to fourth holding cycles HL1 to HL4) at low driving frequency. The display apparatus may drive the display panel 100 with a second light emission time OT2 longer than the first light emission time OT1 in the later portion of holding cycles (e.g. the fifth to seventh holding cycles HL5 to HL7) at low driving frequency.

By increasing the light emission time in the later portion of holding cycles at the low driving frequency, the luminance of the later portion of holding cycles at the low driving frequency may be increased.

The luminance of the display panel 100 during the seventh holding cycle HL7 which is the last holding cycle of FIG. 8B may be less decreased compared with the luminance decrease in the seventh holding cycle of FIG. 8A. A luminance of the seventh holding cycle HL7 may be lower than a luminance of a writing cycle WR by a second difference DF2 which is smaller than the first difference DF1. Because the light emission time is increased in the later portion of holding cycles at the low driving frequency, the second luminance difference DF2 between the last holding cycle and the writing cycle following the last holding cycle may be small compared with the first luminance difference DF1 of FIG. 8A, and the flicker of the display panel 100 may be reduced.

Referring to FIG. 8B, during the write cycle WR and the earlier portion of the holding cycles, the pixel may emit light during a first light emission duration t1 which corresponds to the first light emission time OT1 of FIG. 8A. The earlier portion of the holding cycles may be the first to fourth holding cycles HL1 to HL4. Likewise, during the later portion of the holding cycles, the pixel may emit light during a second light emission duration t2 which corresponds to the second light emission time OT2. The later portion of the holding cycles may be the fifth to seventh holding cycles HL5 to HL7. For example, during the writing cycle WR, the pixel may emit light during the first light emission time duration t1 and, during the fifth holding cycle HL5, the pixel may emit light during the second light emission time duration t2. The second light emission time duration t2 may be equal to or greater than the first light emission time duration t1.

The second time duration t2 for each cycle of the later portion of the holding cycles may correspond to the second light emission time OT2. Each cycle of the later portion of the holding cycles may have same time duration compared with the other cycles of the later portion of the holding cycles. Alternatively, the second time duration t2 for each cycle of the later portion of the holding cycles may be different from the time duration of the other cycles of the later portion of the holding cycles. For example, a light emission time duration of the fifth holding cycle HL5 may be different from a light emission time duration of the sixth holding cycle HL6. Likewise, the light emission time duration of the sixth holding cycle HL6 may be different from a light emission time duration of the seventh holding cycle HL7.

Although the number of the earlier portion of the holding cycles having the first light emission time OT1 is four and the number of the later portion of the holding cycles having the second light emission time OT2 is three in FIG. 8B, the present inventive concept is not limited to the number of the holding cycles.

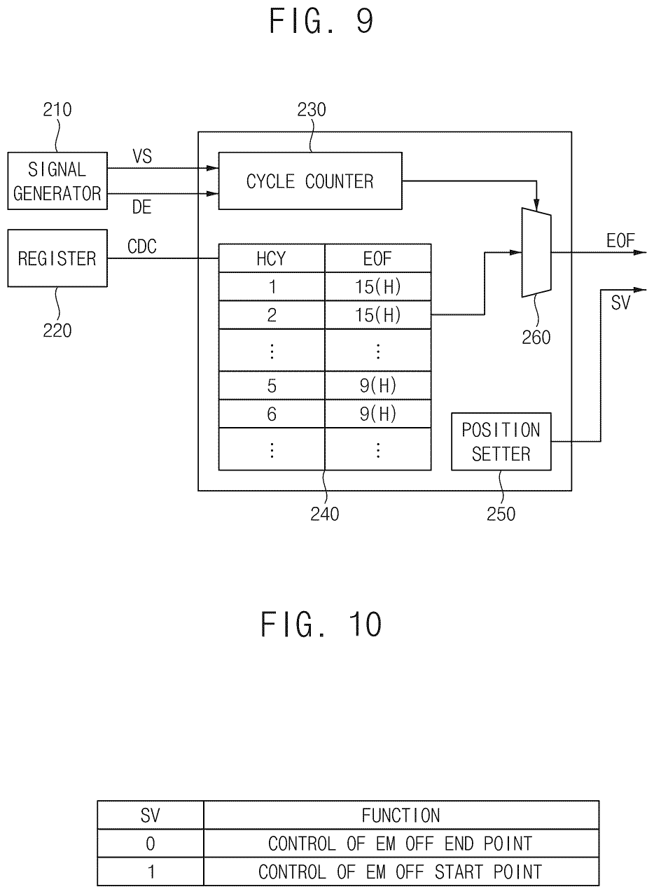

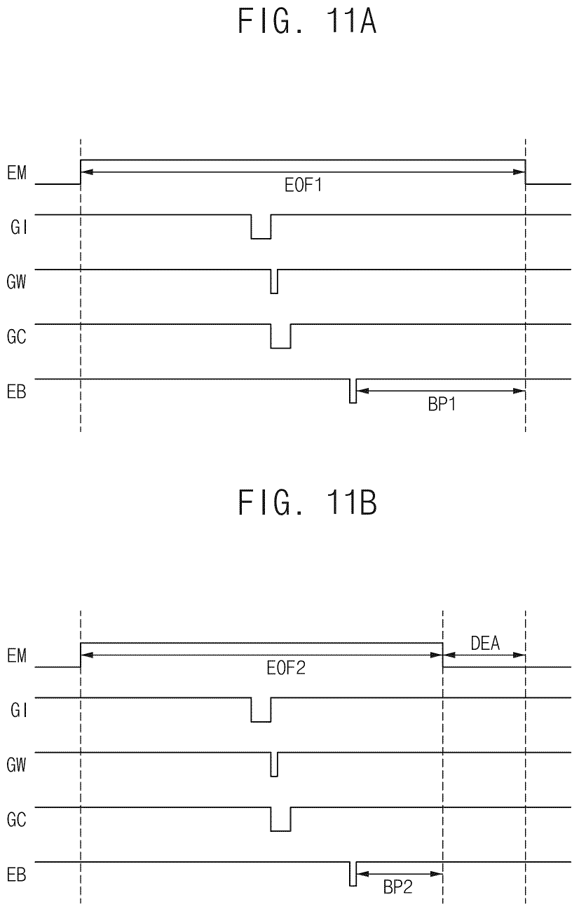

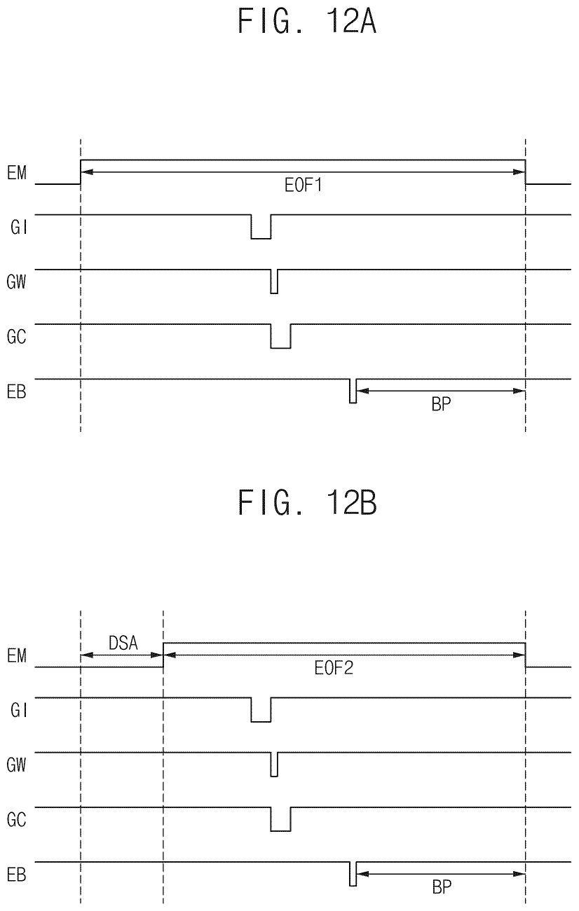

FIG. 9 is a block diagram illustrating the driving controller 200 of FIG. 1. FIG. 10 is a table illustrating a setting value of the position setter 250 of FIG. 9. FIGS. 11A and 11B are a timing diagram illustrating a method of adjusting an end point of an off duration of an emission signal EM of FIG. 10. FIGS. 12A and 12B are a timing diagram illustrating a method of adjusting the start point of the off duration of the emission signal EM of FIG. 10.

Referring to FIGS. 1 to 12B, the driving controller 200 may determine whether a present cycle is the writing cycle WR or the holding cycle based on the control signal CONT. The driving controller 200 controls for the data voltage VDATA to be written into the pixel and the light emitting element EE of the pixel to emit light based on the data voltage VDATA during the writing cycle WR. The driving controller 200 further controls for the data voltage VDATA not to be written into the pixel and the light emitting element EE of the pixel to emit light based on the stored data voltage in the pixel during the holding cycles HL.

The driving controller 200 may count the holding cycles and determine a holding cycle number of a present holding cycle among the holding cycles. For example, the driving controller 200 may determine holding cycle number 1 for the first holding cycle immediately following the writing cycle, and may determine holding cycle number 5 for the fifth holding cycle among the holding cycles.

The driving controller 200, based on the holding cycle number, may determine an emission on time and an emission off time EOF of the present holding cycle.

The driving controller 200 may change the emission off time EOF by adjusting at least one of an end point of the off duration of the emission signal EM and a start point of the off duration of the emission signal EM according to a setting value SV.

For example, when the holding cycle number of the present holding cycle is determined to be equal to or greater than a predetermined holding cycle reference number, the driving controller 200 may increase the emission on time to be longer than a reference emission on time. The holding cycle reference number may be a reference with which the driving controller 200 may determine whether to maintain reference emission on time or to adjust the emission on time. When the present holding cycle number is smaller than the holding cycle reference number, the driving controller 200 may determine to maintain reference emission on time. When the present holding cycle number is equal to or greater than the holding cycle reference number, the driving controller 200 may determine to adjust emission on time.

For example, when the predetermined holding cycle reference number is five in FIG. 8B, the driving controller 200 may increase the emission on time for the fifth holding cycle HL5 and for holding cycles following the fifth holding cycle HL5 (e.g. the sixth holding cycle and the seventh holding cycle HL6 and HL7). Therefore, the emission on times of the fifth to seventh holding cycle HL5 to HL7 may be gradually increased and become longer than the reference emission on time until a new writing cycle WR starts. The reference emission on time may corresponds to OT1 of FIG. 8B and an increased emission on time may correspond to OT2 of FIG. 8B. Referring to FIG. 9, the reference emission on time may be adjusted and the emission off time EOF may be set differently. For example, the emission off time EOF may be set to one cycle minus 15 horizontal cycles (15H). For the holding cycle in which the emission on time is adjusted to be increased, the emission off time EOF may be set to one cycle minus 9 horizontal cycles (9H).

When the light emission time is increased in the later portion of the holding cycles at the low driving frequency, a luminance may increase due to a hysteresis characteristic of the driving switching element T1 in a low grayscale range. In addition, when the holding cycle number of the present holding cycle is equal to or greater than the predetermined holding cycle reference number, the display panel driver may increase a bias voltage VBIAS applied to the driving switching element T1 of the pixel to be greater than a reference bias voltage. By increasing the bias voltage VBIAS applied to the driving switching element T1 in the later portion of the holding cycles, the luminance increase due to the hysteresis characteristic of the driving switching element T1 in the low grayscale range may be compensated.

The driving controller 200 may include a signal generator 210 generating a vertical start signal VS and a data enable signal DE, and a cycle counter 230 determining whether the present cycle is a writing cycle WR or a holding cycle HL based on the vertical start signal VS and the data enable signal DE. The cycle counter 230 further determines the number of the present holding cycle among the holding cycles HL based on the vertical start signal VS and the data enable signal DE when the holding cycles HL are repeated in a driving sequence.

For example, when the cycle counter 230 receives pulses of the data enable signal DE repeatedly after receiving the vertical start signal VS, the cycle counter 230 may determine the present cycle as the writing cycle WR. When the cycle counter 230 does not receive the pulses of the data enable signal DE after receiving the vertical start signal VS, the cycle counter 230 may determine the present cycle as the holding cycle HL.

The driving controller 200 may further include a lookup table 240 storing the emission off times EOF corresponding to the holding cycle numbers HCY.

The driving controller 200 may further include a register 220, in which the register stores an emission off setting CDC, and is configured to determine the emission off times EOF for the holding cycle numbers HCY based on the emission off setting CDC. The emission off setting CDC may include a holding cycle number HCY for selecting an emission off times EOF corresponding to the holding cycle number HCY in the lookup table 240.

The driving controller 200 may further include an emission off time output circuit 260. The emission off time output circuit 260 may receive the holding cycle number HCY of the present holding cycle from the cycle counter 230 and may output the emission off time EOF corresponding to the holding cycle number HCY from the lookup table 240. The emission off time output circuit 260 may be implemented with a multiplexer.

The driving controller 200 may further include a position setter 250. The position setter 250 may output a setting value SV with which the emission driver 600 may determine whether to change the end point of the off duration of the emission signal EM or to change the start point of the off duration of the emission signal EM.

The emission driver 600 may generate the emission signal EM based on the emission off time EOF received from the emission off time output circuit 260 and the setting value SV received from the position setter 250, and provide the emission signal EM to the pixel.

As shown in FIG. 10, when the setting value SV is a first value, for example, a logic-low level, the display panel driver may advance the end point of the off duration of the emission signal EM to decrease the emission off time EOF.

Referring to FIG. 11A, the reference emission on time may be determined by a reference emission off time EOF1. Referring to FIG. 11B, the emission on time may be increased and become longer than the reference emission on time, and the increased emission on time may be determined by an emission off time EOF2. As shown in FIG. 11B, the end point of the off duration of the emission signal EM may be advanced by a first decreasing value DEA. The emission off time EOF may be decreased from EOF1 to EOF2 and emission on time may be increased accordingly.

When the setting value SV is a second value, for example, a logic-high level, the display panel driver may delay the start point of the off duration of the emission signal EM to decrease the emission off time EOF.

Referring to FIG. 12A, the reference emission on time may be determined by a reference emission off time EOF1. Referring to FIG. 12B, the emission on time may be increased and become longer than the reference emission on time, and the increased emission on time may be determined by an emission off time EOF2. As shown in FIG. 12B, the start point of the off duration of the emission signal EM may be delayed by a second decreasing value DSA. The emission off time EOF may be decreased from EOF1 to EOF2 and emission on time may be increased accordingly.

As indicated in FIG. 11A, a time duration between an active pulse of the bias gate signal EB and the end point of the off duration of the emission signal EM may be referred to as a first bias period BP1 in which the bias voltage VBIAS is applied to the driving switching element T1. In FIG. 11B, a time duration between an active pulse of the bias gate signal EB and the end point of the off duration of the emission signal EM may be referred to as a second bias period BP2.

When the end point of the off duration of the emission signal EM is advanced to decrease the emission off time EOF, the time duration of the bias period may be reduced from the first bias period BP1 to the second bias period BP2, and the time duration of the bias period in which the bias voltage VBIAS is applied to the driving switching element T1 may be decreased.

For preventing the time duration of the bias period to be decreased, the setting value SV may be set to the second value, and the start point of the off duration of the emission signal EM may be delayed to reduce the overall emission off time EOF. When the start point of the off duration of the emission signal EM is delayed to reduce the overall emission off time EOF, the time duration of the bias period may be maintained as shown in FIG. 12B.

According to an embodiment, while the display apparatus drives the display panel 100 during the holding cycles HL at low driving frequency, the display apparatus may perform the light emission time control to increase the light emission time in the later portion of the holding cycles HL.

As the light emission time increases in the later portion of the holding cycles (e.g. HL5 to HL7), the luminance may actually increase due to the hysteresis characteristic of the driving switching element T1 in the low grayscale range, and the duration of the bias period in which the bias voltage VBIAS applied to the driving switching element T1 may be increased in the later portion of the holding cycles (e.g. HL5 to HL7).

As the display apparatus performs the light emission time control, the duration of the bias period in which the bias voltage VBIAS is applied to the driving switching element T1 may be decreased from the first bias period BP1 to the second bias period BP2 as shown in FIGS. 11A and 11B. For preventing an undesired effect from the increase of the duration of the bias period, one of the end point of the off duration of the emission signal EM and the start point of the off duration of the emission signal EM may be selectively adjusted when adjusting the light emission time of the pixel.

Therefore, the luminance difference of the display panel 100 may be reduced in the low grayscale range at the low driving frequency. Accordingly, the flicker of the display panel 100 due to the luminance difference may be prevented or reduced, and the display quality of the display panel 100 may be enhanced.

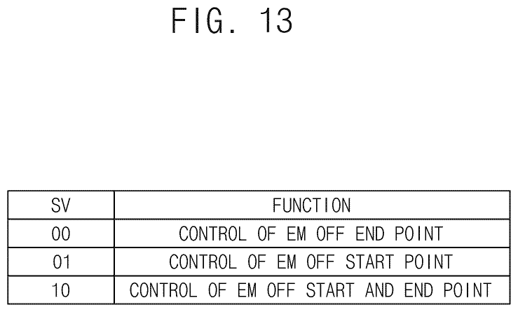

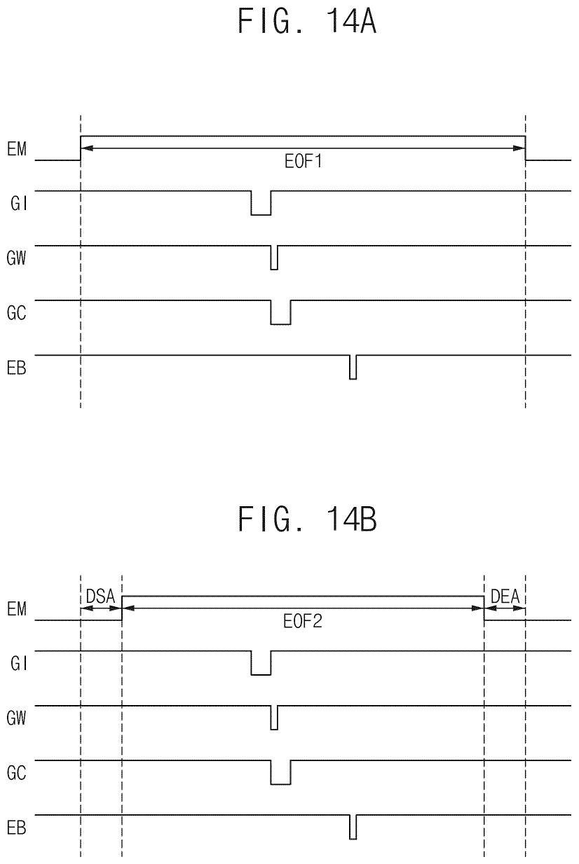

FIG. 13 illustrates a method of adjusting an emission off time according to a setting value of a position setter of the display apparatus. FIGS. 14A and 14B are a timing diagram illustrating a method of adjusting both of a start point and an end point of an off duration of an emission signal EM of FIG. 13.

Referring to FIG. 13, the setting value of the position setter may be set differently from the setting value of FIG. 10.

Referring to FIGS. 1 to 9 and FIGS. 11 to 14, the driving controller 200 may include a position setter 250. The position setter 250 may output a setting value SV with which the emission driver 600 may determine whether to change the end point of the off duration of the emission signal EM or to change the start point of the off duration of the emission signal EM.

The emission driver 600 may generate the emission signal EM based on the emission off time EOF received from the emission off time output circuit 260 and the setting value SV received from the position setter 250 and output the emission signal EM to the pixel.

As shown in FIG. 13, when the setting value SV is a first value which may be “00,” the display panel driver may advance the end point of the off duration of the emission signal EM to decrease the emission off time EOF.

Referring to FIG. 11A, the reference emission on time may be determined by a reference emission off time EOF1. Referring to FIG. 11B, the emission on time may be increased and become longer than the reference emission on time, and the increase of emission on time may be determined by an emission off time EOF2. As shown in FIG. 11B, the end point of the off duration of the emission signal EM may be advanced by a first decreasing value DEA. The emission off time EOF may be decreased from EOF1 to EOF2 and emission on time may be increased accordingly.

When the setting value SV is a second value which may be “01,” the display panel driver may delay the start point of the off duration of the emission signal EM to decrease the emission off time EOF.

Referring to FIG. 12A, the reference emission on time may be determined by a reference emission off time EOF1. Referring to FIG. 12B, the emission on time may be increased and become longer than the reference emission on time, and the increased emission on time may be determined by an emission off time EOF2. As shown in FIG. 12B, the start point of the off duration of the emission signal EM may be delayed by a second decreasing value DSA, and the emission off time EOF may be decreased from EOF1 to EOF2 and emission on time may be increased accordingly.

As indicated in FIG. 11A and FIG. 11B, duration times from an active pulse of the bias gate signal EB to the end point of the off duration of the emission signal EM may be referred to as a first bias period BP1 and a second bias period BP2 respectively, in which the bias voltage VBIAS is applied to the driving switching element T1.

When the end point of the off duration of the emission signal EM is advanced to decrease the emission off time EOF, the duration of the bias period may be reduced from the first bias period BP1 to the second bias period BP2, and the duration of the bias period in which the bias voltage VBIAS is applied to the driving switching element T1 may be decreased.

For preventing an undesired effect from the increase of the duration of the bias period, the setting value SV may be set to the second value which may be “01,” and the start point of the off duration of the emission signal EM may be delayed to reduce overall emission off time EOF. When the start point of the off duration of the emission signal EM is delayed to reduce overall emission off time EOF, the duration of the bias period may be maintained as shown in FIG. 12B.

When the setting value SV is a third value which may be “10,” the display panel driver may advance the end point of the off duration of the emission signal EM and delay the start point of the off duration of the emission signal EM to reduce overall emission off time EOF.

Referring to FIG. 13, when the setting value SV is the third value which may be “10,” the display panel driver may advance the end point of the off duration of the emission signal EM and delay the start point of the off duration of the emission signal EM to reduce the overall emission off time EOF.

Referring to FIG. 14A, the reference emission on time may be determined by a reference emission off time EOF1. Referring to FIG. 14B, the emission on time may be increased and become longer than the reference emission on time, and the increased emission on time may be determined by an emission off time EOF2. As shown in FIG. 14B, the end point of the off duration of the emission signal EM may be advanced by a third decreasing value DEA and the start point of the off duration of the emission signal EM may be delayed by a fourth decreasing value DSA, and the overall emission off time EOF may be decreased from EOF1 to EOF2.

According to an embodiment, when the display apparatus drives the display panel 100 at low driving frequency driving, the display apparatus may perform the light emission time control to increase the light emission time in the later portion of the holding cycles.

The luminance may be increased due to the hysteresis characteristic of the driving switching element T1 in the low grayscale range. When the light emission time is increased in the later portion of the holding cycles (e.g. HL5 to HL7), the bias voltage VBIAS applied to the driving switching element T1 may be increased in the later portion of holding cycles.

As the display apparatus performs the light emission time control, the duration of the bias period in which the bias voltage VBIAS is applied to the driving switching element T1 may be decreased from the first bias period BP1 to the second bias period BP2 as shown in FIGS. 11A and 11B. For preventing an undesired effect from the increase of the duration of the bias period, both the end point of the off duration of the emission signal EM and the start point of the off duration of the emission signal EM may be adjusted.

Therefore, the luminance difference of the display panel 100 may be reduced in the low grayscale range at the low driving frequency, and the flicker of the display panel 100 due to the luminance difference may be prevented or reduced, thereby the display quality of the display panel 100 may be enhanced.

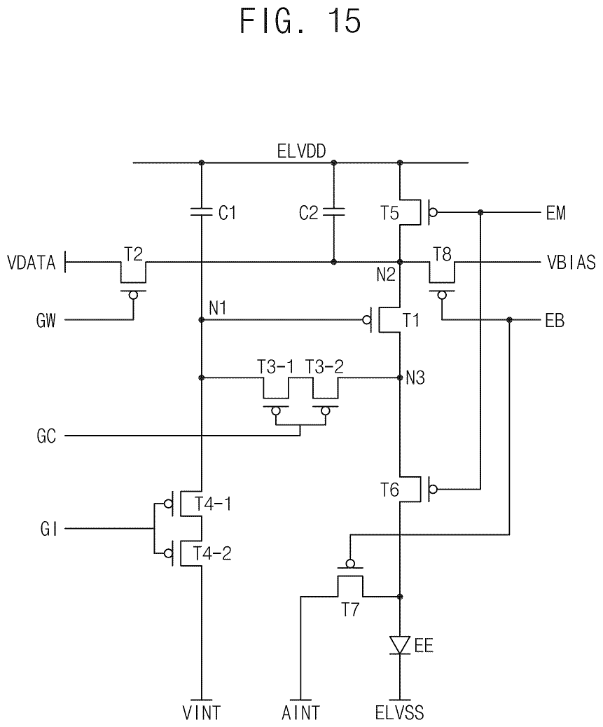

FIG. 15 is a circuit diagram illustrating a pixel of the display panel 100.

The display apparatus may include a pixel circuit which is different from the pixel circuit of FIG. 3

Referring to FIG. 15, the pixel may include a compensation switching element T3-1 and T3-2 connected to the control electrode N1 of the driving switching element T1 and the second electrode N3 of the driving switching element T1.

The compensation switching element may include a first compensation transistor and a second compensation transistor T3-1 and T3-2 connected to each other in series. The first compensation transistor T3-1 may include a control electrode receiving the compensation gate signal GC, a first electrode connected to the control electrode N1 of the driving switching element T1 and a second electrode connected to a first intermediate node connected to the second compensation transistor T3-2. The second compensation transistor T3-2 may include a control electrode receiving the compensation gate signal GC, a first electrode connected to the first intermediate node and a second electrode connected to the second electrode N3 of the driving switching element T1.

Because the compensation switching element includes two transistors T3-1 and T3-2 connected to each other in series, the leakage current through the compensation switching element may be reduced, and the level of the data voltage VDATA applied to the control electrode N1 of the driving switching element T1 and stored in a first capacitor C1 may be preserved better compared with a case in which the compensation switching element include a single transistor.

The pixel may include a data initialization switching element T4-1 and T4-2 connected to the control electrode N1 of the driving switching element T1 and applying the initialization voltage VINT to the control electrode N1 of the driving switching element T1.

More particularly, the data initialization switching element may include a first data initialization transistor T4-1 and a second data initialization transistor T4-2 connected to each other in series. The first data initialization transistor T4-1 may include a control electrode receiving the data initialization gate signal GI, a first electrode connected to a second intermediate node and a second electrode connected to the control electrode N1 of the driving switching element T1. The second data initialization transistor T4-2 may include a control electrode receiving the data initialization gate signal GI, a first electrode receiving the initialization voltage VINT and a second electrode connected to the second intermediate node.

Because the data initialization switching element includes two transistors T4-1 and T4-2 connected to each other in series, the leakage current through the data initialization switching element may be reduced, and the level of the data voltage VDATA applied to the control electrode N1 of the driving switching element T1 and stored in the first capacitor C1 may be preserved better compared with a case in which the data initialization switching element include a single transistor.

According to an embodiment, when the display apparatus drives for the display panel 100 during the holding cycles HL at the low driving frequency, the display apparatus may perform the light emission time control to increase the light emission time in the later portion of the holding cycles.

The luminance may actually increase due to the hysteresis characteristic of the driving switching element T1 in the low grayscale range because the light emission time is increased in the later portion of the holding cycles (e.g. HL5 to HL7), and the duration of bias period in which the bias voltage VBIAS applied to the driving switching element T1 may be increased in the later portion of holding cycles (e.g. HL5 to HL7).

For preventing an undesired effect from the increase of the duration of the bias period in which the bias voltage VBIAS is applied to the driving switching element T1 by the light emission time control, one of the end point of the off duration of the emission signal EM and the start point of the off duration of the emission signal EM may be selectively adjusted while adjusting the light emission time of the pixel.

Therefore, the luminance difference of the display panel 100 may be reduced in the low grayscale range at the low driving frequency, and the flicker of the display panel 100 due to the luminance difference may be prevented or reduced, thereby the display quality of the display panel 100 may be enhanced.

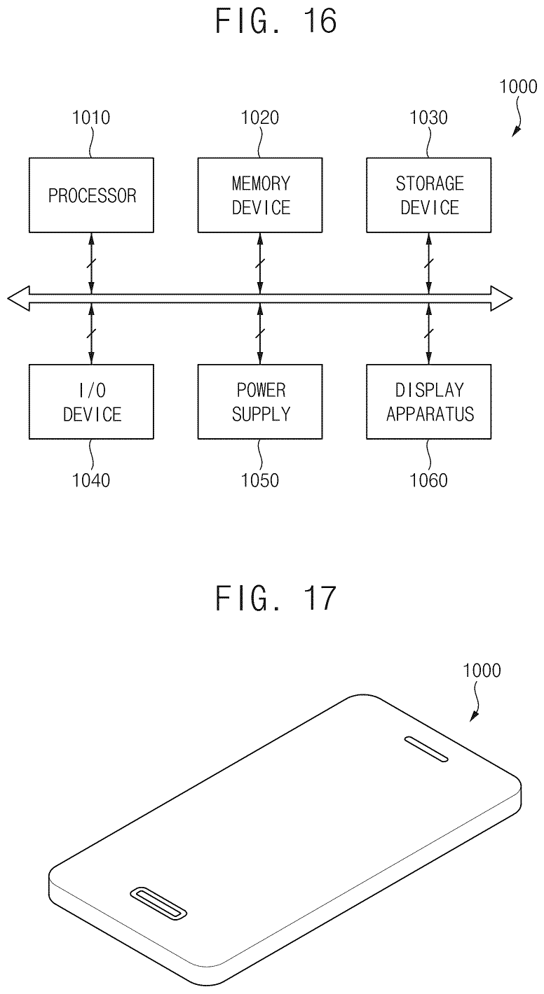

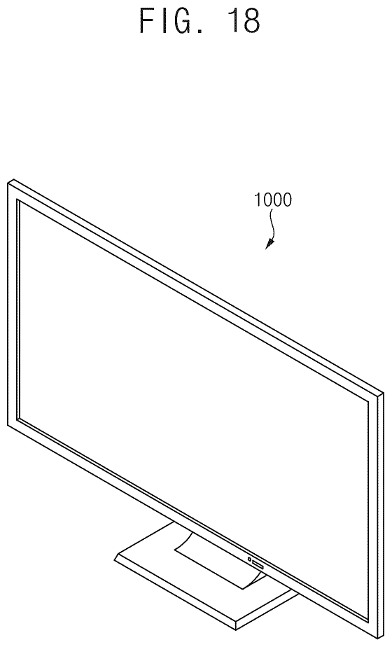

FIG. 16 is a block diagram illustrating an electronic apparatus 1000 according to an embodiment of the present inventive concept. FIG. 17 illustrates a smart phone as an example of the electronic apparatus 1000 of FIG. 16. FIG. 18 illustrates a monitor as an example of the electronic apparatus 1000 of FIG. 16.

Referring to FIGS. 16 to 18, the electronic apparatus 1000 may include a processor 1010, a memory device 1020, a storage device 1030, an input/output (I/O) device 1040, a power supply 1050, and a display apparatus 1060. The display apparatus 1060 may be the display apparatus of FIG. 1. In addition, the electronic apparatus 1000 may include a plurality of ports for communicating with a video card, a sound card, a memory card, a universal serial bus (USB) device, and other electronic apparatuses.

Although a smartphone and a monitor are illustrated as examples of the electronic apparatus 1000, the electronic apparatus 1000 is not limited thereto. For example, the electronic apparatus 1000 may include a television, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, and a data bus. Additionally, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. The memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. The display apparatus 1060 may be integrated into the I/O device 1040. The power supply 1050 may provide power for operations of the electronic apparatus 1000. The display apparatus 1060 may be coupled to other components via the buses or other communication links.

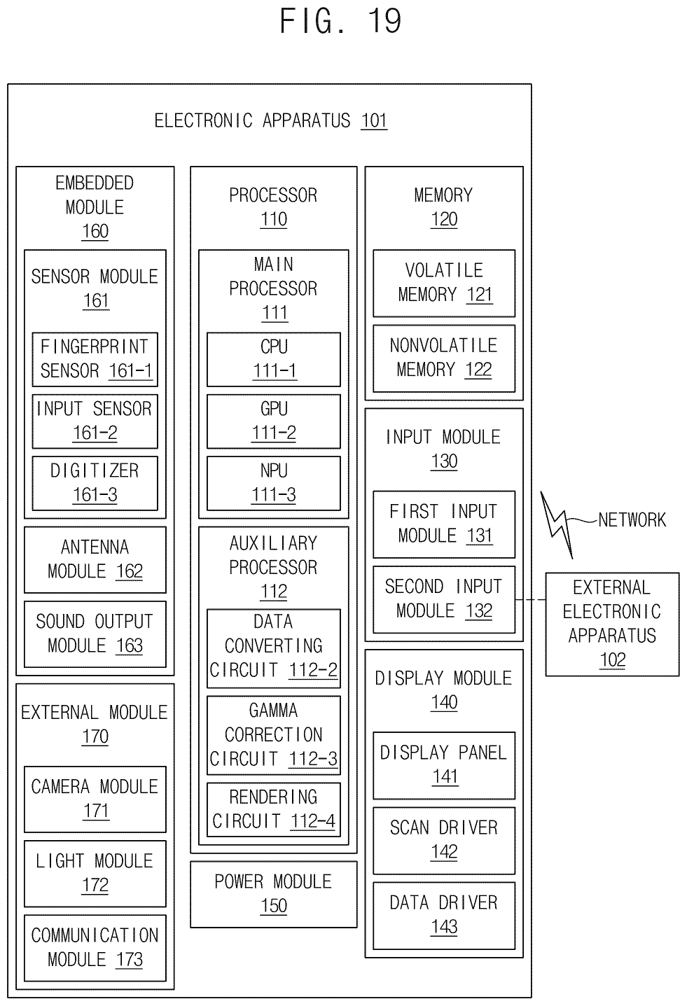

FIG. 19 is a block diagram illustrating an electronic apparatus 101 according to an embodiment of the present inventive concept.

Referring to FIGS. 1 to 19, an electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 transfers image data corresponding to a captured image obtained through the camera module 171 to the display module 140. The display module 140 may display an image corresponding to the captured image through the display panel 141.

When a personal information authentication is executed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

When a music streaming icon displayed on the display module 140 is selected, the processor 110 obtains a user input through the input sensor 161-2 and activates a music streaming application stored in the memory 120. When a music execution command is received by the music streaming application, the processor 110 activates a sound output module 163 to provide sound information corresponding to the music execution command to the user.

The electronic apparatus 101 may include various components for performing operations described above. Some elements of the electronic apparatus 101 may be integrated into one element, or one element may be divided into two or more elements.

The electronic apparatus 101 may communicate with an external electronic apparatus 102 through a network (e.g. a short-range wireless communication network or a long-range wireless communication network). The electronic apparatus 101 may include the processor 110, the memory 120, the input module 130, the display module 140, a power module 150, an embedded module 160, and an external module 170. Some elements of the electronic apparatus 101 may be optional and other elements not listed above may be additionally adopted. Some of the above-described elements such as the sensor module 161, an antenna module 162 or the sound output module 163 may be integrated into other element such as the display module 140.

The processor 110 may execute software to control at least one other hardware or software element of the electronic apparatus 101 and to perform various data processing or operations on the hardware or software components. According to an embodiment, as at least a portion of the data processing or the operations may store instructions or data received from other elements such as the input module 130, the sensor module 161 or a communication module 173 in a volatile memory 121, and may process the instructions or data stored in the volatile memory 121 and store the processing result in a nonvolatile memory 122.

The processor 110 may include a main processor 111 and an auxiliary processor 112. The main processor 111 may include at least one of a central processing unit (CPU) 111-1 and an application processor (AP). The main processor 111 may further include any one or more of a graphic processing unit (GPU) 111-2, a communication processor (CP) and an image signal processor (ISP). The main processor 111 may further include a neural processing unit (NPU) 111-3. The neural network processing unit 111-3 is a processor specialized in processing an artificial intelligence model. The artificial intelligence model may be generated through a machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN) and a deep Q-networks or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element or each may be implemented as independent elements. A single chip may include the processing units integrated into one element, and a plurality of chips may include the processing units implemented in several independent elements.

The auxiliary processor 112 may include a controller. The controller may include an interface conversion circuit and a timing control circuit. The controller receives an image signal from the main processor 111, converts a data format of the image signal in compliance with interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and may compensate the image data such that the image is displayed with a desired luminance according to characteristics of the electronic apparatus 101 or a user setting or may convert the image data to reduce a power consumption or to compensate the image data for afterimages. The gamma correction circuit 112-3 may convert the image data or a gamma reference voltage for the image displayed on the electronic apparatus 101 to have desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g. the main processor 111 or the controller). At least one of the data converting circuit 112-2, the gamma correction circuit 112-3 and the rendering circuit 112-4 may be integrated into a data driver 143.

The memory 120 may store various data used by at least one element (e.g. the processor 110 or the sensor module 161) of the electronic apparatus 101 and input data or output data for commands related thereto. The memory 120 may include at least one of the volatile memory 121 and the nonvolatile memory 122.

The input module 130 may receive commands or data from the outside of the electronic apparatus 101 (e.g. the user or the external electronic apparatus 102), in which the commands or data may be used by the elements (e.g. the processor 110, the sensor module 161 or the sound output module 163) of the electronic apparatus 101.

The input module 130 may include a first input module 131 for receiving commands or data from the user and a second input module 132 for receiving commands or data from the external electronic apparatus 102. The first input module 131 may include a microphone, a mouse, a keyboard, a key (e.g. a button) or a pen (e.g. a passive pen or an active pen). The second input module 132 may support a designated protocol capable of connecting wired or wireless to the external electronic apparatus 102. According to an embodiment, the second input module 132 may include a high definition multimedia interface (HDMI), a universal serial bus (USB) interface, an SD card interface, or an audio interface. The second input module 132 may include a connector physically connected to the external electronic apparatus 102, for example, an HDMI connector, a USB connector, an SD card connector, or an audio connector (e.g. a headphone connector).

The display module 140 provides video information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light emitting display panel or an inorganic light emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be mounted on the display panel 141 as a driving chip. Alternatively, the scan driver 142 may be integrated on the display panel 141. For example, the scan driver 142 may include an amorphous silicon TFT gate driver circuit (ASG) integrated on the display panel 141, a low temperature polycrystalline silicon (LTPS) TFT gate driver circuit integrated on the display panel 141, or an oxide semiconductor TFT gate driver circuit (OSG) integrated on the display panel 141. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. Alternatively, the light emission driver and the scan driver 142 may be integrated into the scan driver 142.

The data driver 143 receives a control signal from the controller and converts the image data into an analog voltage (e.g. the data voltage) and output the data voltages to the display panel 141 in response to the control signal.

The data driver 143 may be integrated into another element (e.g. the controller). The functions of the interface conversion circuit and the timing control circuit of the controller described above may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell, or a fuel cell. The power module 150 may include a power management integrated circuit (PMIC). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor or a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure bio-signal such as a blood pressure, a moisture, or a body fat. For example, when a user touches a part of his body to a sensor layer or a sensing panel for a certain period of time, the input sensor 161-2 may detect the bio-signal based on a change in an electric field caused by the part of the body, in which the display module 140 may output corresponding information.

The digitizer 161-3 may generate a data value corresponding to the coordinated information input by the pen. The digitizer 161-3 generates an amount of electromagnetic change by the input as a data value. The digitizer 161-3 may detect an input by the passive pen or transmit/receive data to/from the active pen.

At least one of the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one of the fingerprint sensor 161-1, the input sensor 161-2 and the digitizer 161-3, for example, the digitizer 161-3, may be disposed under the display panel 141.

At least two or more of the fingerprint sensor 161-1, the input sensor 161-2 and the digitizer 161-3 may be integrated into the sensing panel in a process. When at least two or more of the fingerprint sensor 161-1, the input sensor 161-2 and the digitizer 161-3 are integrated into the sensing panel, the sensing panel may be disposed between the display panel 141 and a window disposed over an upper surface of the display panel 141. According to an embodiment, the sensing panel may be disposed on the window. The present inventive concept may not be limited to a position of the sensing panel.

At least one of the fingerprint sensor 161-1, the input sensor 161-2 and the digitizer 161-3 may be embedded in the display panel 141. For example, at least one of the fingerprint sensor 161-1, the input sensor 161-2 and the digitizer 161-3 is formed simultaneously with the display panel 141 through a process of forming elements included in the display panel 141 (e.g. light emitting elements or transistors).

In addition, the sensor module 161 may generate an electrical signal or a data value corresponding to an internal state or an external state of the electronic apparatus 101. For example, the sensor module 161 may further include a gesture sensor, a gyro sensor, a barometric pressure sensor, a magnetic sensor, an acceleration sensor, a grip sensor, a proximity sensor, a color sensor, an IR (infrared) sensor, a biosensor, a temperature sensor, a humidity sensor, or an illuminance sensor.

The antenna module 162 may include one or more antennas for transmitting a signal or power to outside or receiving a signal or power from outside. The communication module 173 may transmit a signal to an external electronic apparatus or receive a signal from an external electronic apparatus through an antenna suitable for the communication. An antenna pattern of the antenna module 162 may be integrated with an element of the display module 140 (e.g. the display panel 141) or the input sensor 161-2.

The sound output module 163 is a device for outputting sound signals to the outside of the electronic apparatus 101. For example, the sound output module 163 may include a speaker used for general purposes such as playing multimedia or recording and a receiver used exclusively for receiving a call. The receiver may be formed integrally with or separately from the speaker. A sound output pattern of the sound output module 163 may be integrated with the display module 140.

The camera module 171 may capture still images and moving images. The camera module 171 may include one or more lenses, an image sensor, or an image signal processor. The camera module 171 may further include an infrared camera capable of determining a presence or an absence of a user, the user's location, and the user's gaze.

The light module 172 may provide a light. The light module 172 may include a light emitting diode or a xenon lamp. The light module 172 may operate in conjunction with the camera module 171 or operate independently.

The communication module 173 may support establishment of a wired or wireless communication channel between the electronic apparatus 101 and the external electronic apparatus 102 and communication through the established communication channel. The communication module 173 may include one or both of a wireless communication module such as a cellular communication module, a short-distance wireless communication module, or a global navigation satellite system (GNSS) communication module and a wired communication module such as a local area network (LAN) communication module, or a power line communication module. The communication module 173 may communicate with the external electronic apparatus 102 through a short-range communication network such as Bluetooth,

WiFi direct or infrared data association (IrDA) or a long-distance communication network such as a cellular network, the Internet, or a computer network (e.g. LAN or WAN). The various types of communication modules 173 described above may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. For example, the processor 110 may generate image data corresponding to input data applied through a mouse or an active pen, and output the generated image data to the display module 140 or the processor 110 may generate command data corresponding to the input data and output the generated command data to the camera module 171 or the light module 172. When input data is not received from the input module 130 for a certain period of time, the processor 110 converts an operation mode of the electronic apparatus 101 into a low power mode or a sleep mode so that a power consumption of the electronic apparatus 101 may be reduced.

The processor 110 outputs commands or data to the display module 140, the sound output module 163, the camera module 171 or the light module 172 based on sensed data received from the sensor module 161. For example, the processor 110 may compare authentication data applied by the fingerprint sensor 161-1 with authentication data stored in the memory 120, and then execute an application according to the comparison result. The processor 110 may execute commands or output corresponding image data to the display module 140 based on the sensed data sensed by the input sensor 161-2 or the digitizer 161-3.

When the sensor module 161 includes a temperature sensor, the processor 110 may receive temperature data for the temperature measured from the sensor module 161 and may perform luminance correction on the image data based on the temperature data.

The processor 110 may receive determined data about the presence or the absence of the user, the user's location, and the user's gaze from the camera module 171. The processor 110 may further perform luminance correction on the image data based on the determined data. For example, the processor 110, which determines the presence or the absence of the user through an input from the camera module 171, may display image data having the luminance corrected by the data converting circuit 112-2 or the gamma correction circuit 112-3 to the display module 140.

Some of the above elements may be connected to each other through a communication method between peripheral devices such as a bus, a general purpose input/output (GPIO), a serial peripheral interface (SPI), a mobile industry processor interface (MIPI), or an ultra-path interconnect (UPI) link to exchange signals (e.g. commands or data) with each other. The processor 110 may communicate with the display module 140 through an agreed interface. For example, the processor 110 may communicate with the display module 140 through any one of the above communication methods. The present invention may not be limited to the above communication methods.

The electronic apparatus 101 according to various embodiments disclosed in the disclosure may be various types of apparatuses. For example, the electronic apparatus 101 may include at least one of a portable communication apparatus (e.g. a smart phone), a computer apparatus, a portable multimedia apparatus, a portable medical apparatus, a camera, a wearable device and a home appliance. The electronic apparatus 101 according to the embodiment of the disclosure may not be limited to the aforementioned apparatuses.

For example, the display panel 100 of FIG. 1 may correspond to the display panel 141 of FIG. 19. For example, the driving controller 200 of FIG. 1 may correspond to the controller of the auxiliary processor 112 of FIG. 19. For example, the gate driver 300 and the emission driver 600 of FIG. 1 may correspond to the scan driver 142 of FIG. 19. For example, the data driver 500 of FIG. 1 may correspond to the data driver 143 of FIG. 19.

According to the embodiments of the display apparatus, the display quality of the display panel may be enhanced.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display apparatus comprising:
a display panel including a pixel; and
a display panel driver including a gate driver, a data driver, and an emission driver, in which the gate driver, the data driver, and the emission driver are configured to generate a gate signal, a data voltage, and an emission signal respectively, and to provide the gate signal, the data voltage, and the emission signal to the display panel,
wherein the display panel driver is further configured to:
determine whether a driving cycle in a driving sequence is a writing cycle or a holding cycle, in which, during the writing cycle, the display panel is configured to receive the data voltage and write the data voltage into the pixel, and to drive a light emitting element of the pixel to emit light based on the received data voltage, and during the holding cycle, the display panel is configured to drive the light emitting element of the pixel to emit light based on the data voltage stored in the pixel;
determine a holding cycle number of a present holding cycle when holding cycles are repeated in the driving sequence; and
determine an emission off time based on the holding cycle number of the present holding cycle by adjusting at least one of an end point of an off duration of the emission signal and a start point of the off duration of the emission signal according to a setting value.

2. The display apparatus of claim 1, wherein, when the holding cycle number of the present holding cycle is equal to or greater than a predetermined holding cycle reference number, the display panel driver is configured to decrease the emission off time by advancing the end point of the off duration of the emission signal and/or by delaying the start point of the off duration of the emission signal according to the setting value.

3. The display apparatus of claim 2, wherein, when the holding cycle number of the present holding cycle is equal to or greater than the predetermined holding cycle reference number, the display panel driver is configured to increase a bias voltage applied to a driving switching element of the pixel to be greater than a reference bias voltage.

4. The display apparatus of claim 1, wherein, when the setting value is a first value, the display panel driver is configured to advance the end point of the off duration of the emission signal to decrease the emission off time, and when the setting value is a second value, the display panel driver is configured to delay the start point of the off duration of the emission signal to reduce the emission off time.

5. The display apparatus of claim 4, wherein, when the setting value is a third value, the display panel driver is configured to advance the end point of the off duration of the emission signal and to delay the start point of the off duration of the emission signal to reduce the emission off time.

6. The display apparatus of claim 1, wherein the display panel driver further includes:
a signal generator configured to generate a vertical start signal and a data enable signal; and
a cycle counter configured to determine whether a present driving cycle is the writing cycle or the holding cycle based on the vertical start signal and the data enable signal, and the cycle counter is further configured to determine the holding cycle number of the present holding cycle based on the vertical start signal and the data enable signal when the holding cycles are repeated in the driving sequence.

7. The display apparatus of claim 6, wherein the cycle counter determines the present driving cycle as the writing cycle when the cycle counter receives pulses of the data enable signal repeatedly after receiving the vertical start signal, and the cycle counter determines the present driving cycle as the holding cycle when the cycle counter does not receive the pulses of the data enable signal after receiving the vertical start signal.

8. The display apparatus of claim 6, wherein the display panel driver further includes a lookup table configured to store the emission off time corresponding to the holding cycle number.

9. The display apparatus of claim 8, wherein the display panel driver further includes a register configured to determine the emission off time corresponding to the holding cycle number based on an emission off setting, and to output the emission off time corresponding to the holding cycle number from the lookup table.

10. The display apparatus of claim 8, wherein the display panel driver further includes an emission off time output circuit configured to receive the holding cycle number of the present holding cycle from the cycle counter, and to output the emission off time corresponding to the holding cycle number from the lookup table.

11. The display apparatus of claim 10, wherein the display panel driver further comprises:
a position setter configured to output the setting value with which the emission driver determines whether to change the end point of the off duration of the emission signal or to change the start point of the off duration of the emission signal; and
an emission driver configured to generate the emission signal based on the emission off time received from the emission off time output circuit and the setting value received from the position setter, and to provide the emission signal to the pixel.

12. The display apparatus of claim 1, wherein the pixel comprises:
a driving switching element including a control electrode of the driving switching element connected to a first node, a first electrode of the driving switching element connected to a second node and a second electrode of the driving switching element connected to a third node;
a bias switching element including a control electrode of the bias switching element configured to receive a bias gate signal, a first electrode of the bias switching element configured to receive a bias voltage and a second electrode of the bias switching element connected to the second node;
a first emission switching element including a control electrode of the first emission switching element configured to receive the emission signal, a first electrode of the first emission switching element configured to receive a first power voltage and a second electrode of the first emission switching element connected to the second node;
a second emission switching element including a control electrode of the second emission switching element configured to receive the emission signal, a first electrode of the second emission switching element connected to the third node and a second electrode of the second emission switching element connected to a first electrode of the light emitting element;
a data writing switching element including a control electrode of the data writing switching element configured to receive a data writing gate signal, a first electrode of the data writing switching element configured to receive the data voltage and a second electrode of the data writing switching element connected to the second node;
a compensation switching element including a control electrode of the compensation switching element configured to receive a compensation gate signal, a first electrode of the compensation switching element connected to the first node and a second electrode of the compensation switching element connected to the third node;
a data initialization switching element including a control electrode of the data initialization switching element configured to receive a data initialization gate signal, a first electrode of the data initialization switching element configured to receive an initialization voltage and a second electrode of the data initialization switching element connected to the first node; and
a light emitting element initialization switching element including a control electrode of the light emitting element initialization switching element configured to receive the bias gate signal, a first electrode of the light emitting element initialization switching element configured to receive a light emitting element initialization voltage and a second electrode of the light emitting element initialization switching element connected to the first electrode of the light emitting element.

13. The display apparatus of claim 12, wherein the compensation switching element includes two transistors connected to each other in series, and the data initialization switching element includes two transistors connected to each other in series.

14. A method of driving a display apparatus, the method comprising:
determining whether a driving cycle in a driving sequence is a writing cycle or a holding cycle, in which, during the writing cycle, the display apparatus is configured to generate a data voltage and write the data voltage into a pixel, and to drive a light emitting element of the pixel to emit light based on the received data voltage, and during the holding cycle, the display apparatus is configured to drive the light emitting element of the pixel to emit light based on the data voltage stored in the pixel;
determining a holding cycle number of a present holding cycle when holding cycles are repeated in a driving sequence;
determining an emission off time based on the holding cycle number of a present holding cycle by adjusting at least one of an end point of an off duration of an emission signal and a start point of the off duration of the emission signal according to a setting value; and
generating the emission signal based on the emission off time and the setting value, and providing the emission signal to the pixel.

15. The method of claim 14, wherein, when the holding cycle number of the present holding cycle is equal to or greater than a predetermined holding cycle reference number, the emission off time is decreased by advancing the end point of the off duration of the emission signal and/or by delaying the start point of the off duration of the emission signal according to the setting value.

16. The method of claim 15, wherein, when the holding cycle number of the present holding cycle is equal to or greater than the predetermined holding cycle reference number, a bias voltage applied to a driving switching element of the pixel is increased to be greater than a reference bias voltage.

17. The method of claim 14, wherein, when the setting value is a first value, the end point of the off duration of the emission signal is advanced to decrease the emission off time, and when the setting value is a second value, the start point of the off duration of the emission signal is delayed to reduce overall emission off time.

18. The method of claim 17, wherein, when the setting value is a third value, the end point of the off duration of the emission signal is advanced and the start point of the off duration of the emission signal is delayed to reduce the emission off time.

19. The method of claim 14, wherein a present driving cycle is determined to be one of the writing cycle or the holding cycle based on a vertical start signal and a data enable signal, and the holding cycle number of the present holding cycle is determined based on the vertical start signal and the data enable signal when the holding cycles are repeated in the driving sequence.

20. An electronic apparatus comprising:
a processor configured to output input image data and an input control signal;
a display panel including a pixel; and
a display panel driver including a gate driver, a data driver, and an emission driver, in which the gate driver, the data driver, and the emission driver are configured to generate a gate signal, a data voltage and an emission signal respectively, and to provide the gate signal, the data voltage, and the emission signal to the pixel,
wherein the display panel driver is further configured to:
determine whether a driving cycle in a driving sequence is a writing cycle or a holding cycle, in which, during the writing cycle, the display panel is configured to receive the data voltage, write the data voltage into the pixel, and to drive a light emitting element of the pixel to emit light based on the received data voltage, and during the holding cycle, the display panel is configured not to receive the data voltage, and to drive the light emitting element of the pixel to emit light based on the data voltage stored in the pixel;
determine a holding cycle number of a present holding cycle when holding cycles are repeated in the driving sequence; and
determine an emission off time based on the holding cycle number of the present holding cycle by adjusting at least one of an end point of an off duration of the emission signal and a start point of the off duration of the emission signal according to a setting value,
wherein the display panel driver is further configured to determine whether the driving cycle is the writing cycle or the holding cycle based on the input control signal from the processor.
